(19) United States
(12) Patent Application Publication
(10) Pub. No.: US 2010/0031256 A1
(43) Pub. Date: Feb. 4, 2010

(54) METHOD FOR ESTABLISHING VIRTUAL OPERATING SYSTEM

(75) Inventor: Wei-Ling HSIEH, Bejing (CN)

Correspondence Address: GREENBLUM & BERNSTEIN, P.L.C., 1950 ROLAND CLARKE PLACE, RESTON, VA, 20191, US

(73) Assignee: EUNOVATION INT'L LIMITED

(21) Appl. No.: 12/267,997

(22) Filed: Nov. 10, 2008

(30) Foreign Application Priority Data
Aug. 4, 2008 (CN) 200810117733.8

(51) Int. Cl. G06F 9/455

(52) U.S. Cl. 718/1

(57) ABSTRACT

The present invention provides a method for establishing a virtual operating system (VOS). The method comprises: obtaining an instruction message for loading a VOS, wherein the instruction message comprises identification information of application programs corresponding to the VOS to be loaded; obtaining configuration information of a VOS plug-in required for executing each application program corresponding to the identification information from a virtual environment database; and establishing a link between the VOS plug-ins required for executing an application program and a VOS core part according to the configuration information, and loading the VOS plug-ins into user-mode memory space. The present invention decompose a VOS into one core and many plug-ins, for code sharing, which is a great flexibility because independent functions can be combined on demand. The present invention facilitates followed-up dynamic updating and upgrading of the VOS, enables every application program to have fittest VOS and dynamically adjusts the functionality of the VOS according to requirements so as to fulfill the current situation.

### CROSS-REFERENCE TO RELATED APPLICATIONS

This application claims priority to Chinese Patent Application No. 200810117733.8, filed on Aug. 4, 2008, entitled “Method for Establishing Virtual Operating System”, which is incorporated herein by reference in its entirety.

### FIELD OF THE TECHNOLOGY

The present invention relates to the field of computer technology, especially to a method for establishing a virtual operating system.

### BACKGROUND OF THE INVENTION

With continuous development of computer technology, the functions of a computer are getting more and stronger and cover every aspect of people's lives, including studying, entertainment, office-working, shopping, and so on. Although mobile storage devices or storage servers have brought convenience to people so as to enable users to work on different computers, working environments of different computers and application software installed which are widely divergent also have brought users with huge troubles. A virtual operating system (VOS) can solve such troubles. A VOS is a program for simulating an operating system (OS). A VOS runs above the operating system and below the application program. The VOS provides the user with an operating environment different from the real operating system and modifies the application program executed above so as to accord with the temporal requirement. In the prior art, the VOS loaded into the memory space serves as a whole. For all the application programs in the virtual environment load the same VOS, it is impossible to load the fittest VOS according to practical requirements of application programs and dynamically adjust the loaded VOS, which results in a bad adaptability.

### SUMMARY OF THE INVENTION

The present invention provides a method for establishing a VOS in order to solve the defect of bad adaptability of the loaded VOS in the prior art so as to enhance the adaptability of the VOS.

The present invention provides a method for establishing a VOS. The method comprises
obtaining an instruction message for loading a VOS, wherein the instruction message comprises identification information of an application program corresponding to the VOS to be loaded;
obtaining configuration information of a VOS plug-in required for executing the application program corresponding to the identification information from a virtual environment database; and
establishing a link between the VOS plug-in required for executing the application program and a VOS core part according to the configuration information, and loading the VOS plug-in into user-mode memory space.

The method for establishing a VOS provided in the present invention takes resource as a unit to form a VOS plug-in so as to implement resource share. For not every application program has the same resource requirement, there will be flexibility and elasticity by isolating the resource plug-in with an independent function and performing combination invoking when required. The VOS invokes the resource and modifies application programs in the way of a resource plug-in, which facilitates followed-up dynamic updating and upgrading of the VOS, enables every application program to have its own exclusive VOS and dynamically adjusts the function of the VOS according to requirements so as to implement individuated modification.

The present invention will be described in more detail with reference to the drawings and embodiments.

### BRIEF DESCRIPTION OF THE DRAWINGS

FIG. 1 is a schematic view illustrating the structure of the virtual environment in accordance with the present invention;

FIG. 2 is a schematic view illustrating the implementation of the VOS in accordance with the present invention;

FIG. 3 is a flowchart illustrating the method for establishing a VOS in accordance with the present invention.

### DETAILED DESCRIPTION OF THE PREFERRED EMBODIMENTS

The implementation of the VOS brings great convenience to people's lives. The VOS can simulate the operating interface to which users are accustomed so as to enable users to use operating system configured by their accustomed operating manner and user interface at another place. With the help of VOS, software can be put in a mobile storage device or a storage server so as to enable users to use the same familiar system environment at a different place without carrying heavy laptop computers. A VOS is not a real operating system but a special program responsible for holding up actions of application programs and change actions of application programs according to requirements. The VOS plays a role of intermediate between application programs and the operating system.

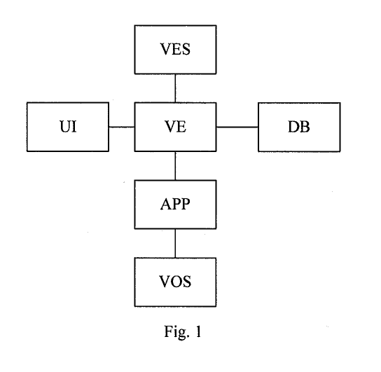

FIG. 1 is a schematic view illustrating the structure of the virtual environment in accordance with the present invention. As shown in FIG. 1, the established virtual environment (VE) is connected to a virtual environment server (VES) responsible for comprehensive management of the VE. The VE provides the user with a user interface (UI). The user performs operation in the UI just like performing the operation in a practical operating system. In a VE, user can execute many application programs (APPs). Whenever one APP is executed, a VOS exclusively belonging to the APP will be generated and loaded. The VOS is responsible for modifying the interface between the APP and the operating system to make it invoke the VOS instead so as to complete the executing of the APP. Every VE has its own virtual environment database (DB). In the DB, relevant VOS configuration information for executing the APP in the VE is stored.

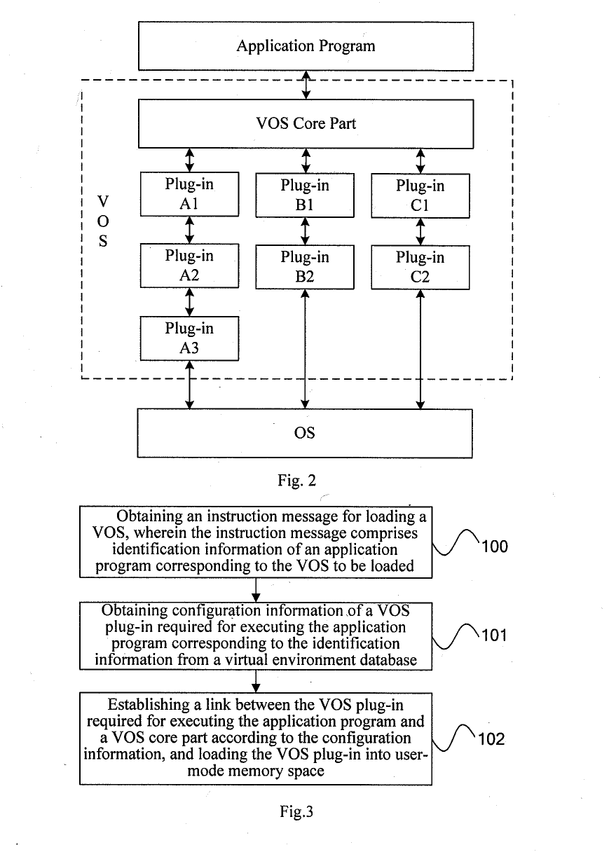

The method for establishing a VOS provided by the present invention divides the VOS loaded in the user-mode memory space into two parts. One part is a VOS core part; the other part is a VOS plug-in. The VOS core part is the common part for executing all the APPs. The VOS core part keeps unchanged. The main function of the VOS core part is to receive instructions given to the VOS from outside and perform corresponding treatment. The VOS plug-ins (hereafter referred to plug-ins for simplicity) are components for modifying interfaces between APPs and the operating system. Each VOS plug-in implements a single interface (such as networking) and has its own purpose. During executing an APP, if it is required to complete a function, a plug-in implementing the function will be connected to the VOS core part. When an APP is executed, the plug-in is invoked to implement the corresponding function for meeting the individuality requirement of executing the APP. The above-mentioned VOS core part and VOS plug-in can both exist in the form of dynamic link library (DLL) file. FIG. 2 is a schematic view illustrating the implementation of the VOS in accordance with the present invention. As shown in FIG. 2, in order to execute an application program, the VOS loaded into the user-mode memory space is divided into two parts—VOS core part and plug-in strings. The VOS core link. In the VOS core part, many VOS plug-in strings are hanged and the last plug-in in each plug-in string links to the operating system. The method for establishing a VOS will be described in more detail as follows. FIG. 3 is a flowchart illustrating the method for establishing a VOS in accordance with the present invention. As shown in FIG. 3, the method comprises the following steps:

In step 100, an instruction message for loading a VOS is obtained. The instruction message comprises identification information of an application program corresponding to the VOS to be loaded.

In the virtual environment, when executing an application program, the virtual environment server may, according to the instruction message for executing the application program, allocate memory space for the application program in the user-mode memory space and load executing code of the application program into the allocated use-mode memory space. Specifically, after receiving an operating instruction for executing an application program in the virtual environment, the virtual environment server allocates a memory space for the application program in the user-mode memory space, which is adapted to contain the executing code for executing the application program. Every running application program has its own memory space. The virtual environment server loads the executing code used for executing the application program, i.e. the executing program, into the memory space. After the executing code used for the application program is loaded, the VOS is loaded.

In step 101, the configuration information of the VOS plug-in required for the corresponding application program for executing the identification information is obtained from the virtual environment database.

The virtual environment server searches the virtual environment database in the virtual environment and finds the configuration information of the application program corresponding to the identification information included in instruction message loaded into the VOS. Through the configuration information, the virtual environment server learns which VOS plug-in should be connected to the VOS core part in order to execute the application program, combines the VOS core part and the VOS plug-in to create the VOS and loads the VOS into the user-mode memory space.

In step 102, according to the configuration information, the link between the VOS plug-in and the VOS core part required for executing the application program is established and is loaded into the user-mode memory space.

After knowing which plug-ins are to be loaded, and the linking order among the plug-ins, from the configuration information stored in the virtual environment database, each plug-in should be connected to the VOS core part directly or indirectly. According to the configuration information, the link between the VOS plug-in and the VOS core part required for executing the application program is established. According to the configuration information, VOS plug-ins with the same kind of interfaces required for executing the application program are connected together, and become a plug-in string. The link between the plug-in string and the VOS core part is established. The VOS core part and the plug-in string finishing the link are loaded into the user-mode memory space. In the above-mentioned process of combing the plug-in string, according to configuration information, VOS plug-ins with the same kind of interfaces required for executing the application program may be combined to be a plug-in string in preset order.

One VOS core may have a plurality of plug-in strings. The combination of the plug-in string may be formed by combing the plug-ins with the same kind of interfaces into the same plug-in string. The interfaces of the plug-ins may be the network functions, file system functions, text rendering functions, and so on. Each plug-in string belongs to the same kind of interfaces. Specifically as shown in FIG. 2, the A1. A2 and A3 with the same kind of interfaces are combined and become a plug-in string A with the file system functions. The B1 and B2 with the same kind of interfaces are combined to be a plug-in B with the networking functions. The C1 and C2 with the same kind of interfaces are combined to be a plug-in string C with the text-rendering function. The plug-in strings have no order between each other, that is, if the VOS is going to invoke the plug-in string A, there is no requirement to do so via the plug-in string B or the plug-in string C. Similarly, when the VOS is going to invoke the plug-in string B, there is no requirement to do so via the plug-in string A or the plug-in string C. Every plug-in string is linked to the VOS core part independently. Furthermore, each plug-in in the plug-in string has an order. The order of plug-ins may also influence the manner of the system operation. When the VOS is loaded for the first time, which plug-ins are to be loaded and their orders is obtained from the virtual environment database. The VOS core part and these plug-in strings are connected together and loaded into the user-mode memory space.

In the running process of the application program, the VOS core part may receive the instruction message from the virtual environment server, resolve the instruction message and learn the changing requirement about the VOS plug-ins, i.e. how to dynamically change the plug-ins, including setting the parameter of a plug-in, loading a plug-in, unloading a plug-in, and adjusting the order of the plug-ins. The VOS core part dynamically changes the operating system plug-in weakly linked to the VOS core part according to the instruction message for changing the plug-in. If the requirement is to set the parameter of the plug-in, the VOS will make correct configuration on the plug-in so as to change the action of the plug-in. If the requirement is to load the plug-in, the VOS core part will dynamically load and link the VOS plug-in to be loaded in the corresponding plug-in string at the corresponding position according to the instruction message. If the requirement is to unload the plug-in, the VOS core part will dynamically remove the VOS plug-in to be unloaded in the corresponding plug-in string according to the instruction message for unloading the plug-in. If the requirement is to adjust the order of the plug-in, according to the instruction message for adjusting the order of the plug-in, the VOS core part will dynamically adjust the order of linking VOS plug-ins in the corresponding plug-in string according to the requirement of adjusting the order of the plug-in.

By taking the loading of a plug-in as an example, the step of dynamically changing the loading of the plug-in will be described in more detail as follows. The VOS core part is provided with an instruction receiver for intercepting, resolving and executing the instruction. The VOS intercepts the instruction and receives the instruction sent to the VOS, resolves the received instruction, learns a modification requirement, obtains the required resource plug-in according to the modification requirement, invokes the plug-in and implements the modification of the APP. For example, when Microsoft Word is running, if abnormality happens, it is required to shut sown the connection between Microsoft Word and the network. The virtual environment sends a network disconnection instruction to the VOS. During the interception, the VOS receives and resolves the instruction to learn that it is required to disconnect Microsoft Word from the network. The VOS insert a dummy networking plug-in to the VOS, which does not pass the networking request to the OS, i.e. cuts off the connection to the network. The whole process does not influence the running of other application programs in the virtual environment.

The method for establishing a VOS provided by the present invention split VOS into a core and some plug-ins. Because not every application program has the same functional requirement, the pluggable VOS provided by the present invention is very flexible. The VOS invokes the plug-ins to modify application programs. VOS provided by the present invention can also be updated and upgraded at run time, which enables every application program to have its own exclusive VOS and dynamically adjusts the functionality of the VOS according to various requirements so as to implement individuated modification.

Finally, it should be understood that the above embodiments are only used to explain, but not to limit the technical solution of the present invention. In despite of the detailed description of the present invention with referring to above preferred embodiments, it should be understood that various modifications, changes or equivalent replacements can be made by those skilled in the art without departing from the spirit and scope of the present invention and covered in the claims of the present invention.

What is claimed is:

1. A method for establishing a virtual operating system (VOS), comprising:
obtaining an instruction message for loading a VOS, wherein the instruction message comprises identification information of application programs corresponding to the VOS to be loaded;
obtaining configuration information of a VOS plug-ins required for executing the application program corresponding to the identification information from a virtual environment database; and
establishing a link between the VOS plug-ins required for executing the application program and a VOS core part according to the configuration information, and loading the VOS plug-ins into user-mode memory space.

2. The method according to claim 1, wherein the step of establishing a link between the VOS plug-ins required for executing the application program and a VOS core part according to the configuration information, and loading the VOS plug-ins into use-mode memory space comprises:
combining VOS plug-ins which have the same kind of interfaces and are required for executing the application program into a plug-in string according to the configuration information;
establishing the link between the plug-in string and the VOS core part; and
loading the VOS core part and all the required plug-in strings finishing the link into user-mode memory space.

3. The method according to claim 2, wherein the step of combining VOS plug-ins which have the same kind of interfaces and are required for executing the application program into a plug-in string according to the configuration information comprises:
combining VOS plug-ins which have the same kind of interface and are required for executing the application program into a plug-in string in a preset order according to the configuration information.

4. The method according to claim 1, further comprising:
the VOS core part dynamically changing the VOS plug-ins linked to the VOS core part according to instruction messages for changing the plug-ins.

5. The method according to claim 4, wherein the step of the VOS core part dynamically changing the VOS plug-in linked to the VOS core part according to an instruction message for changing the plug-in comprises:
the VOS core part modifying parameters of the VOS plug-ins according to instruction messages for setting plug-in parameters; or
the VOS core part dynamically loading and hanging the VOS plug-ins to be loaded in corresponding positions in the corresponding plug-in strings according to instruction messages for loading plug-ins; or
the VOS core part dynamically removing the VOS plug-in to be unloaded in the corresponding plug-in strings according to instruction messages for unloading plug-ins; or
the VOS core part dynamically adjusting the order of the VOS plug-ins in the corresponding plug-in string based on requirements for adjusting plug-in order according to instruction messages for adjusting plug-in order.

6. The method according to claim 5, before the step of the VOS core part dynamically changing the VOS plug-ins linked to the VOS core part according to instruction messages for changing the plug-ins, further comprising:
the VOS core part receiving the instruction messages and resolving the instruction messages to learn changing requirement of the VOS plug-ins.

7. The method according to claim 2, further comprising:
the VOS core part dynamically changing the VOS plug-ins linked to the VOS core part according to instruction messages for changing the plug-ins.

8. The method according to claim 7, wherein the step of the VOS core part dynamically changing the VOS plug-in linked to the VOS core part according to an instruction message for changing the plug-in comprises:
the VOS core part modifying parameters of the VOS plug-ins according to instruction messages for setting plug-in parameters; or
the VOS core part dynamically loading and hanging the VOS plug-ins to be loaded in corresponding positions in the corresponding plug-in strings according to instruction messages for loading plug-ins; or
the VOS core part dynamically removing the VOS plug-in to be unloaded in the corresponding plug-in strings according to instruction messages for unloading plug-ins; or
the VOS core part dynamically adjusting the order of the VOS plug-ins in the corresponding plug-in string based on requirements for adjusting plug-in order according to instruction messages for adjusting plug-in order.

9. The method according to claim 8, before the step of the VOS core part dynamically changing the VOS plug-ins linked to the VOS core part according to instruction messages for changing the plug-ins, further comprising:
the VOS core part receiving the instruction messages and resolving the instruction messages to learn changing requirement of the VOS plug-ins.

10. The method according to claim 3, further comprising:
the VOS core part dynamically changing the VOS plug-ins linked to the VOS core part according to instruction messages for changing the plug-ins.

11. The method according to claim 10, wherein the step of the VOS core part dynamically changing the VOS plug-in linked to the VOS core part according to an instruction message for changing the plug-in comprises:
the VOS core part modifying parameters of the VOS plug-ins according to instruction messages for setting plug-in parameters; or
the VOS core part dynamically loading and hanging the VOS plug-ins to be loaded in corresponding positions in the corresponding plug-in strings according to instruction messages for loading plug-ins; or
the VOS core part dynamically removing the VOS plug-in to be unloaded in the corresponding plug-in strings according to instruction messages for unloading plug-ins; or
the VOS core part dynamically adjusting the order of the VOS plug-ins in the corresponding plug-in string based on requirements for adjusting plug-in order according to instruction messages for adjusting plug-in order.

12. The method according to claim 11, before the step of the VOS core part dynamically changing the VOS plug-ins linked to the VOS core part according to instruction messages for changing the plug-ins, further comprising:
the VOS core part receiving the instruction messages and resolving the instruction messages to learn changing requirement of the VOS plug-ins.
